(19) United States
(12) Patent Application Publication
(10) Pub. No.: US 2021/0027001 A1
(43) Pub. Date: Jan. 28, 2021

(54) Method for Predicting Sealing Reliability of Soft Packing Lithium Ion Battery

(71) Applicant: Beihang University, Beijing (CN)

(72) Inventors: Yunxia CHEN, Beijing (CN); Yuxuan CUI, Beijing (CN); Kunsong LIN, Beijing (CN); Rui KANG, Beijing (CN); Biao ZHANG, Beijing Ningde (CN)

(21) Appl. No.: 16/901,252

(22) Filed: Jun. 15, 2020

(30) Foreign Application Priority Data
Jul. 23, 2019 (CN) 201910665441.6

(51) Int. Cl. G06F 30/23; H01M 10/0525; H01M 2/16; G06F 30/10

(52) U.S. Cl. CPC G06F 30/23; H01M 10/0525; H01M 10/4228; G06F 30/10; H01M 2/16

(57) ABSTRACT

A method for predicting sealing reliability of a soft packing lithium ion battery, includes steps of determining a key degradation mechanism, constructing a pressure-time model, determining a pressure-stress space model, obtaining a maximum peeling force-strength model, determining a maximum peeling force-time model, constructing a maximum peeling force-space model, and ultimately predicting sealing reliability of the soft packing lithium ion battery. Considering influence of variations of air pressure inside the lithium ion battery on a degradation process of the packing sealing material in a whole life cycle, the method for predicting sealing reliability of a soft packing lithium ion battery according to the present disclosure simulates a performance variation trend of each of sealing portions of the lithium ion battery in a practical use process, theoretically calculates the sealing reliability of the soft packing lithium ion battery under different environmental conditions, and performs a strong engineering applicability.

### TECHNICAL FIELD

This disclosure pertains to the technical field of sealing reliability analysis, and in particular relates to a method for predicting sealing reliability of a soft packing lithium ion battery.

### BACKGROUND

Reliability prediction generally refers to estimation of reliability level of products in a use phase according to history information or degradation test results of the products. The packing technology of the soft packing lithium ion battery is not vet mature, and thus leads to sealing failure behaviors such as air leakage and liquid leakage after long-term working, such that the soft packing lithium ion battery and even a battery pack happen failure. Therefore, it is very important to develop a method capable for accurately predicting the sealing reliability of the soft packing lithium ion battery in the whole life cycle.

Currently, research focuses on preparation and selection of novel sealing materials and sealing adhesives and improvement of packing process parameters. Environmental experiments such as high and low temperature and electrolyte corrosion are carried out on packing produced in different manners, and according to its performance, sealing performance level under a normal working condition will be judged. However, these methods do not take sealing degradation effect of the soft packing lithium ion battery during the use process into account. Therefore, there is still a lack of corresponding method research on predicting the sealing reliability of the soft packing lithium ion battery under actual use conditions.

### SUMMARY

To overcome the defects in the prior art, the present disclosure provides a method for predicting sealing reliability of a lithium ion battery under a time-varying load condition based on a multi-dimensional stress-strength interference theory. Influence of the change of internal air pressure of the lithium ion battery on the degradation process of an external packing sealing material in the whole life cycle has been considered in a time dimension, and stress distribution generated by dispersity of sealing strength for sealing respective portions and intensity of pressure acting on different portions and a corresponding strength degradation rate difference have been considered in a space dimension. The method simulates a change trend of the sealing performance of the soft packing lithium ion battery in the actual use process, implements an interference calculation on the stress received for sealing and the strength of sealing, and considers dispersion characteristic, and thus evaluates the sealing reliability of the lithium ion battery.

Specifically, the present disclosure provides a method for predicting sealing reliability of a soft packing lithium ion battery, wherein the method includes steps of:

S1, determining a key degradation mechanism:

wherein sealing failure modes of the soft packing lithium ion battery are analyzed to find out key failure modes and carry out mechanism analysis, and determine key failure mechanisms and respective sensitive stresses, and according to analysis results of the mechanism, the key failure mechanisms of sealing failure of the soft packing lithium ion battery are determined as aging, creeping and electrolyte corrosion, and the respective sensitive stresses are determined as temperature, pressure and water content, respectively;

S2, constructing a pressure-time model:

wherein by counting pressure-time data of samples of the different soft packing lithium ion batteries, model data is fitted by using a. maximum likelihood fitting method, to obtain the pressure-time model as follows:

$$P r ( t ) = Γ ( t ; {α}_{1} ( t ) , {λ}_{1} )$$

$${α}_{1} ( t ) = {λ}_{1} \{ {A}_{f} exp ( \frac{{C}_{f}}{T} ) t + {Pr}_{0} \}$$

wherein Γ(t;α(t), λ) represents a Gamma process evolving over time t; α(t) is a shape parameter of the process; λ is a scale parameter; t is time; T is temperature; Pr₀ is a mean value of an initial pressure; A_{f} and C_{f} are constants; the pressure-time model means that the pressure of the soft packing lithium ion battery follows the Gamma process along with change of the time, and the temperature affects the pressure by influencing shape parameter values of the Gamma process;

S3, constructing a pressure-stress space model:

wherein an internal pressure of the soft packing lithium ion battery uniformly acts on an inner face of the packing, so as to generate a tensile force at a seal, and generate a normal positive stress at a sealing and bonding interface; a relation formula is fitted by establishing a finite element mechanical simulation model_{;} changing the pressure, and extracting results of stress at different positions of a sealing edge, stress values under various pressure conditions are obtained by utilizing the stress simulation on the soft packing lithium ion battery entirely, and thereby constructing the pressure-stress space model as follows:

$$s ( x ) = a \cdot {Pr}^{b} [ 1 - {c ( x - \frac{l}{2} )}^{2} ] 0 < x < l$$

where s is stress; x is a coordinate of a spatial position, representing a distance from the position to an end point of the sealing edge; l is a length of the sealing edge; a, b, c are constants; the pressure-stress space model means that the stress at a certain point on the inner face of the packing and the pressure are in a power function relation, the stress values at the different positions of the same sealing edges are symmetrical with respect to a midpoint of the sealing edge, and the stress at the midpoint of the sealing edge is maximum;

S4, constructing a maximum peeling force-strength model:

geometric properties of the sample and physical properties of the sample material are substituted into a non-linear stripping model for calculation, to establish a quadratic response surface relation formula between a maximum peeling force P and the interface properties, and thus constructing the maximum peeling force-strength model as follows:

P=c₀+c₁\hat{Σ}+c₂δ_{c}+c₃\hat{σ}²+c₄\hat{σ}δ_{c}+c₅δ_{c}²

wherein P is the maximum peeling force, c₀, c₁, c₂, c₃, c₄, c₅ are constants, \hat{Σ} is bonding strength, and δ_{c} is a characteristic length;

S5, constructing a maximum peeling force accelerated degradation model:

according to the analysis results of the failure mechanism, constructing the maximum peeling force accelerated degradation model as follows:

$$\frac{d P}{d t} = {A}_{0} {Pr}^{m} {RH}^{n} exp ( \frac{C}{T} )$$

wherein

$$\frac{d P}{dt}$$

is a degradation rate of the maximum peeling force, A₀ is a test constant, RH is a battery internal water content, Pr is the pressure, C is a ratio of the activation energy to the Boltzmann constant, in is a power law index of the pressure, and n is a power law index of the water content;

and then, introducing the Gamma process to further characterize the degradation process of the maximum peeling force, at this time, constructing the maximum peeling force accelerated degradation model as follows:

$$P ( t ) = Γ ( t ; α ( t ) , λ )$$

$$α ( t ) = λ \{ {P}_{0} - {A}_{0} \cdot {\int }_{0}^{t} {Pr}^{m} {RH}^{n} exp ( \frac{C}{T} ) \cdot d τ \} ;$$

the maximum peeling force accelerated degradation model means that the maximum peeling force follows the Gamma process according to a rule of variation over time, and environmental factors such as the temperature, the pressure and the battery internal water content affect the pressure by affecting the shape parameter values of the Gamma process;

S6, constructing a maximum peeling force space model:

wherein from step S5, it is obtained that the value of maximum peeling force at a certain time follows Gamma distribution, and an initial maximum peeling force at each of the positions follows the same distribution, and thereby constructing the maximum peeling force space model as follows:

P(x+d)=νP(x)+ϵ

ϵ: E(λ)

CDF(ν)=ν^{Ε-1};ν∈[0,1]

P(0)˜Ga(α, λ)

the formula means that the initial maximum peeling force P(x+d) separated by d is generated from the value P(x) of the previous position, wherein e follows an exponential distribution of the parameter λ; ν follows a power law distribution from 0 to 1 and its cumulative distribution function CIF is a power function; the value P(0) of the initial position follows the Gamma distribution; the maximum peeling force at the initial time of each of the positions represented by a stationary process follows the same Gamma distribution, and a correlation coefficient ρ of the two positions distanced by D satisfies relation below:

$$p ( x , x + D ) = {( \frac{α - 1}{α} )}^{\frac{D}{d}}$$

thereby calculating a correlation coefficient according to the test data of the maximum peeling force at each of the positions at the initial time and fitting the value of the positions separated by d;

S7: constructing multi-dimensional stress-strength interference model and predicting the reliability:

wherein according to the models constructed in steps S2 to S6, external load conditions are specified for calculation to obtain a stress-time-position curved surface and a strength-time-position curved surface of the soft packing lithium ion battery, and numerical simulation is implemented according to the stress-strength interference theory, to obtain the reliability value R, and the multi-dimensional stress-strength interference model used for the numerical simulation as follows:

$$R ( t ) = P ( {min}_{x} ( \hat{σ} ( t , x ) - s ( t , x ) ) > 0 )$$

wherein, R represents the reliability, and the multi-dimensional stress-strength interference model means that the reliability R(t) of a certain point t at the time dimension is a probability that the weakest portion at each of the sealing edges is able to normally work at the time t, that is, the probability that the minimum value of the difference between the bonding strength and the bonding stress at each of the positions of the sealing edges is greater than zero.

Preferably, the key failure mode as described in step 1 refers to a failure representation occurring at a highest frequency in the sealing failure types of the soft packing lithium ion battery in the whole life cycle; the key failure mechanism refers to an internal physical or chemical process of the key failure mode; and the sensitive stress refers to an applied load leading to occurrence of the key failure mechanism.

Preferably, the maximum likelihood method as described in step S2 refers to that a plurality of pressure distributions to be obtained and a process parameter set are arbitrarily given, sequentially substituted into known data points to obtain probability density function values, and then all probability density function values are multiplied, so that the likelihood function values are obtained; and according to an optimization algorithm iterative calculation rule, after each iteration, the parameter set corresponding to the larger likelihood function value is selected as the output of this iteration, repeat the process until the difference between the likelihood function values before and after each iteration is less than a given error limit, at this time, the parameter set with the largest likelihood function value is taken as a result, and thus a solution is completed.

Preferably, in step S3, the stress values under various pressure conditions are obtained by carrying out stress simulation on the soft packing lithium ion battery entirely, and specifically steps are as follows:

S31, establishing a geometric model of a soft packing by using three-dimensional modeling software;

S32, importing the geometric model of the soft packing into a simulation software, parameterizing the pressure and mechanical properties of the packing, and establishing a parametric model of the packing;

S33, setting a grid of the packing parameter model in the simulation software, contacting options, determining constraining and loading methods, and carrying out simulation calculation and extracting the maximum stress at the sealing edges.

Preferably, the nonlinear peeling model as described in step S4 refers to solving the maximum peeling force of the sample when applying a symmetrical tensile load under the geometric attribute of the sample and the physical attribute of the sample material by using an elastoplastic mechanic theory, wider the consideration of the nonlinear stress-strain relationship of the packing material.

Preferably, in step S5, an accelerated degradation test under a constant stress condition is carried out based on the maximum peeling force accelerated degradation model, and combination of a number of test sets and a stress level is determined through a test optimization design; accelerated degradation tests at different stress levels are carded out on the soft packing entirely, and the soft packing subjected to degradation at different times is trimmed into samples with equal widths; the maximum peeling force degradation data of samples at different times is obtained through peeling tests of the samples, and the maximum likelihood fitting is used to obtain the values of relevant parameters.

Preferably, the test optimization design as described in step S5 refers to determining the combination of the stress levels by using an orthogonal design method, for carrying out the accelerated degradation tests.

Preferably, in step S7, the numerical simulation is carried out according to the stress-strength interference theory, and obtaining the value of the reliability R specializes in that a sampling program is compiled by using the Monte Carlo method to generate a large number of strength and stress values at different positions at different times for comparison and calculation, and the probability of no failure is taken as a final reliability.

Preferably, when degradation effects caused by aging, creep and electrolyte corrosion are considered in step S4, the bonding strength \hat{σ} and the sealing critical length vary over time in a. proportion k, thereby causing degradation of the maximum peeling force, and an expression for collaboration relationship is as follows:

$$\hat{σ} ( t ) = \hat{σ} ( 0 ) {S}_{1}$$

$${δ}_{c} ( t ) = {δ}_{c} ( 0 ) {S}_{2}$$

$$k = \frac{1 - {S}_{2}}{1 - {S}_{1}}$$

$$P ( t ) = {f}_{1} ( \hat{σ} ( t ) , k )$$

wherein S is an environmental degradation factor within a value range between 0 and 1, and physically means a ratio of reduction of the two parameters of the bonding strength and the critical length caused by the environmental load, while the maximum peeling force-strength model in S4 is denoted as f₁.

Compared with the prior art, the present disclosure has following advantages:

1. the present disclosure provides a calculating expression of the sealing reliability of the soft packing lithium ion battery, which may calculate the sealing reliability of the soft packing lithium ion battery under a dynamic load condition according to simulation and theory, and has a strong engineering applicability;

2. the present disclosure takes the influence and randomness of the external time-varying load on the performance degradation of the packing materials along with the time change into account, which is more in line with the actual use;

3. the present disclosure takes difference, randomness and correlation of the loads applied to different positions of a sealing edge account, which can comprehensively and truly reflect the actual sealing situation.

### BRIEF DESCRIPTION OF THE DRAWINGS

FIG. 1 is a flow chart of the present disclosure;

FIG. 2 is a flow chart of an embodiment of the present disclosure;

FIG. 3 is a stress simulation view of a soft packing according to an embodiment of the present disclosure;

FIG. 4 is a reliability prediction diagram under different temperature conditions according to an embodiment of the present disclosure.

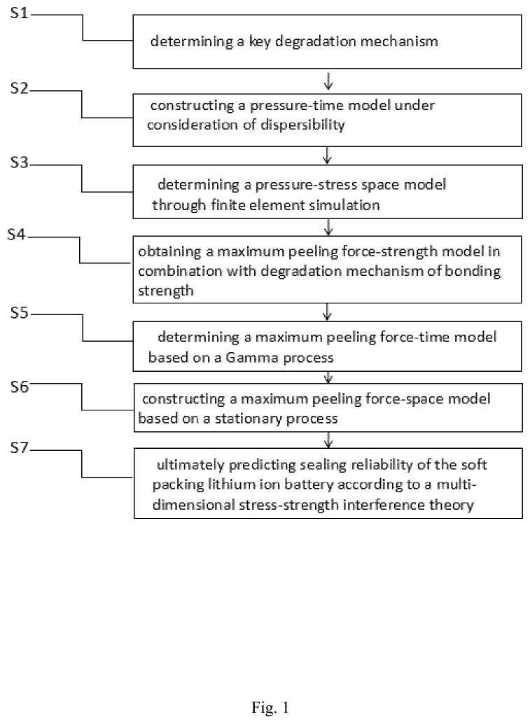

### DETAILED DESCRIPTION

Exemplary embodiments, features and aspects of the present disclosure will be described in detail below with reference to the accompanying drawings. Same reference numbers denote elements with the same or similar functions in the figures. Although various aspects of embodiments are shown in the drawings and are not necessarily drawn to scale, unless otherwise specified.

Specifically, the present disclosure provides a method for predicting sealing reliability of a soft packing lithium ion battery, characterized in that the method includes steps of:

S1, determining a key degradation mechanism:

wherein sealing failure modes of the soft packing lithium ion battery are analyzed to find out key failure modes and carry out mechanism analysis, and determine key failure mechanisms and respective sensitive stresses, and according to analysis results of the mechanism, the key failure mechanisms of sealing failure of the soft packing lithium ion battery are determined as aging, creeping and electrolyte corrosion, and the respective sensitive stresses are determined as temperature, pressure and water content, respectively;

S2, constructing a pressure-time model:

wherein by counting pressure-time data of samples of the different soft packing lithium ion battery, model data is fitted by using a maximum likelihood fitting method, to obtain the pressure-time model as follows:

$$Pr ( t ) = Γ ( t ; {α}_{1} ( t ) , {λ}_{1} )$$

$${α}_{1} ( t ) = {λ}_{1} \{ {A}_{f} exp ( \frac{{C}_{f}}{T} ) t + {Pr}_{0} \}$$

wherein Γ(t;α(t), λ) represents a Gamma process evolving over time t; α(t) is a shape parameter of the process; λ is a scale parameter; t is time; T is temperature; Pr₀ is a mean value of an initial pressure; A_{f} and C_{f} are constants; the pressure-time model means that the pressure of the soft packing lithium ion battery follows the Gamma process along with change of the time, and the temperature affects the pressure by influencing shape parameter values of the Gamma process;

S3, constructing a pressure-stress space model:

wherein an internal pressure of the soft packing lithium ion battery uniformly acts on an inner face of the packing, so as to generate a tensile force at a seal, and generate a normal positive stress at a sealing and bonding interface; a. relation formula. is fitted by establishing a finite element mechanical simulation model, changing the pressure, and extracting results of stress at different positions of a sealing edge, stress values under various pressure conditions are obtained by utilizing the stress simulation on the soft packing lithium ion battery entirely, and thereby constructing the pressure-stress space model as follows:

$$s ( x ) = a \cdot {Pr}^{b} [ 1 - {c ( x - \frac{l}{2} )}^{2} ] 0 < x < l$$

where s is stress; x is a coordinate of a spatial position, representing a distance from the position to an end point of the sealing edge; l is a length of the sealing edge; a, b, c are constants; the pressure-stress space model means that the stress at a certain point on the inner face of the packing and the pressure are in a power function relation, the stress values at the different positions of the same sealing edges are symmetrical with respect to a midpoint of the sealing edge, and the stress at the midpoint of the sealing edge is maximum;

S4, constructing a maximum peeling force-strength mode:

geometric properties of the sample and physical properties of the sample material are substituted into a non-linear stripping model for calculation, to establish a quadratic response surface relation formula between a maximum peeling force P and the interface properties, and thus constructing the maximum peeling force-strength model as follows:

P=c₀+c₁\hat{σ}+c₂δ_{c}+c₃\hat{σ}²+c₄\hat{σ}δ_{c}+c₅δ_{c}²

wherein P is the maximum peeling force, c₀, c₁, c₂, c₃, c₄, c₅ are constants, \hat{σ} is bonding strength, and δ_{c} is a characteristic length;

S5. constructing a maximum peeling force accelerated degradation model:

according to the analysis results of the failure mechanism, constructing the maximum peeling force accelerated degradation model as follows:

$$\frac{d P}{d t} = {A}_{0} {Pr}^{m} {RH}^{n} exp ( \frac{C}{T} )$$

wherein

$$\frac{dP}{d t}$$

is a degradation rate of the maximum peeling force, A₀ is a test constant, RH is a battery internal water content, Pr is the pressure, C is a ratio of the activation energy to the Boltzmann constant, m is a power law index of the pressure, and n is a power law index of the water content;

and then, introducing the Gamma process to further characterize the degradation process of the maximum peeling force, at this time, constructing the maximum peeling force accelerated degradation model as follows:

$$P ( t ) = Γ ( t ; α ( t ) , λ )$$

$$α ( t ) = λ \{ {P}_{0} - {A}_{0} \cdot {\int }_{0}^{t} {Pr}^{m} {RH}^{n} exp ( \frac{C}{T} ) \cdot d τ \} ;$$

the maximum peeling force accelerated degradation model means that the maximum peeling force follows the Gamma process according to a rule of variation over time, and environmental factors such as the temperature, the pressure and the battery internal water content affect the pressure by affecting the shape parameter values of the Gamma process;

S6, constructing a maximum peeling force space model:

wherein from step S5, it is obtained that the value of maximum peeling force at a certain time follows Gamma distribution, and an initial maximum peeling force at each of the positions follows the same distribution, and thereby constructing the maximum peeling force space model as follows:

P(x +d)=νP(x)+ϵ

ϵ: E(λ)

CDF(ν)=ν^{α-1}; ν∈[0,1]

P(0)˜Ga(α, λ)

the formula means that the initial maximum peeling force P(x+d) separated by d is generated from the value P(x) of the previous position, wherein ϵ follows an exponential distribution of the parameter λ; ν follows a power law distribution from 0 to 1 and its cumulative distribution function CDF as a power function; the value P(0) of the initial position follows the Gamma distribution; the maximum peeling force at the initial time of each of the positions represented by a stationary process follows the same Gamma distribution, and a correlation coefficient p of the two positions distanced by D satisfies relation below:

$$ρ ( x , x + D ) = {( \frac{α - 1}{α} )}^{\frac{D}{d}}$$

thereby calculating a correlation coefficient according to the test data of the maximum peeling force at each of the positions at the initial time and fitting the value of the positions separated by d;

S7: constructing multi-dimensional stress-strength interference model and predicting the reliability:

wherein according to the models constructed in steps S2 to S6, external load conditions are specified for calculation to obtain a stress-time-position curved surface and a strength-time-position curved surface of the soft packing lithium ion battery, and numerical simulation is implemented according to the stress-strength interference theory, to obtain the reliability value R, and the multi-dimensional stress-strength interference model used for the numerical simulation as follows:

$$R ( t ) = P ( {min}_{x} ( \hat{σ} ( t , x ) - s ( t , x ) ) > 0 )$$

wherein, R represents the reliability, and the multi-dimensional stress-strength interference model means that the reliability R(t) of a certain point t at the time dimension is a probability that the weakest portion at each of the sealing edges is able to normally work at time t, that is, the probability that the minimum value of the difference between the bonding strength and the bonding stress at each of the positions of the sealing edges is greater than zero.

Preferably, the key failure mode as described in step S1 refers to a failure representation occurring at a highest frequency in the sealing failure types of the soft packing lithium ion battery in the whole life cycle; the key failure mechanism refers to an internal physical or chemical process of the key failure mode; and the sensitive stress refers to an applied load leading to occurrence of the key failure mechanism.

Preferably, the maximum likelihood method as described in step S2 refers to that a plurality of pressure distributions to be obtained and a process parameter set are arbitrarily given, sequentially substituted into known data points to obtain probability density function values, and then all probability density function values are multiplied, so that the likelihood function values are obtained; and according to an optimization algorithm iterative calculation rule, after each iteration, the parameter set corresponding to the larger likelihood function value is selected as the output of this iteration, the process is repeated until the difference between the likelihood function values before and after each iteration is less than a given error limit, at this time, the parameter set with the largest likelihood function value is taken as a result, and thus a solution is completed.

Preferably, in step S3, the stress values under various pressure conditions are obtained by carrying out stress simulation on the soft packing lithium ion battery entirely, and specifically steps are as follows:

S31, establishing a geometric model of a soft packing by using three-dimensional modeling software;

S32, importing the geometric model of the soft packing into a simulation software, parameterizing the pressure and mechanical properties of the packing, and establishing a parametric model of the packing;

S33, setting a grid of the packing parameter model in the simulation software, contacting options, determining constraining and loading methods, and carrying out simulation calculation and extracting the maximum stress at the sealing edges.

Preferably, the nonlinear peeling model as described in step S4 refers to solving the maximum peeling force of the sample when applying a symmetrical tensile load under the geometric attribute of the sample and the physical attribute of the sample material by using an elastoplastic mechanic theory, under the consideration of the nonlinear stress-strain relationship of the packing material.

Preferably, in step S5, an accelerated degradation test under a constant stress condition is carried out based on the maximum peeling force accelerated degradation model, and combination of a number of test sets and a stress level is determined through a test optimization design; accelerated degradation tests at different stress levels are carried out on the soft packing entirely, and the soft packing subjected to degradation at different times is trimmed into samples with equal widths; the maximum peeling force degradation data of samples at different times is obtained through peeling tests of the samples, and the maximum likelihood fitting is used to obtain the values of relevant parameters.

Preferably, the test optimization design as described in step S5 refers to determining the combination of the stress levels by using an orthogonal design method, for carrying out the accelerated degradation tests.

Preferably, in step S7, the numerical simulation is carried out according to the stress-strength interference theory, and obtaining the value of the reliability R specializes in that a sampling program is compiled by using the Monte Carlo method to generate a large number of strength and stress values at different positions at different times for comparison and calculation, and the probability of no failure is taken as a. final reliability.

Preferably, when degradation effects caused by aging, creep and electrolyte corrosion are considered in step S4, the bonding strength \hat{σ} and the sealing critical length δ_{c} vary over time in a proportion k, thereby causing degradation of the maximum peeling force, and an expression for collaboration relationship is as follows:

$$\hat{σ} ( t ) = \hat{σ} ( 0 ) {S}_{1}$$

$${δ}_{c} ( t ) = {δ}_{c} ( 0 ) {S}_{2}$$

$$k = \frac{1 - {S}_{2}}{1 - {S}_{1}^{ }}$$

$$P ( t ) = {f}_{1} ( \hat{σ} ( t ) , k )$$

wherein S is an environmental degradation factor within a value range between 0 and 1, and physically means a ratio of reduction of the two parameters of the bonding strength and the critical length caused by the environmental load, while the maximum peeling force-strength model in S4 is denoted as ƒ₁.

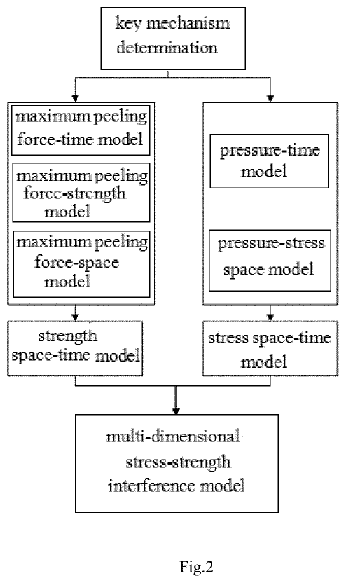

The present disclosure will now be further described in detail with reference to a specific soft packing lithium ion battery for a new energy automobile. As shown in FIG. 2, the specific implementation steps of the present disclosure are as follows:

Step 1: determining a key degradation mechanism

The sealing failure modes of the soft packing lithium ion battery are emphatically analyzed and studied to find out the key failure modes, and analyze the failure mechanism and determine the sensitive stress. According to the theoretical analysis and the actual test results, it turns out that the key failure mechanisms of the sealing failure of the soft packing lithium ion battery include aging, creeping and electrolyte corrosion, and the sensitive stresses are temperature, pressure and water content respectively.

Step 2: constructing a pressure-time model

By counting pressure-time data of samples of the different soft packing lithium ion battery, a Gamma process is used to express the pressure-time relationship, and a maximum likelihood fitting method is used to fit a model data. All the pressure-time data are substituted and the maximum value of the likelihood function is solved, thus the parameter fitting result can be obtained.

Accordingly, the pressure-time model is as follows:

$$Pr ( t ) = Γ ( t ; {α}_{1} , ( t ) , 81100 )$$

$${α}_{1} ( t ) = 81100 \{ 105 exp ( \frac{- 375}{T} ) t + 8210 \}$$

in this formula, the pressure is represented by Pa, the temperature is represented by K, and the tine is represented by days.

Step 3: constructing a pressure-stress space model

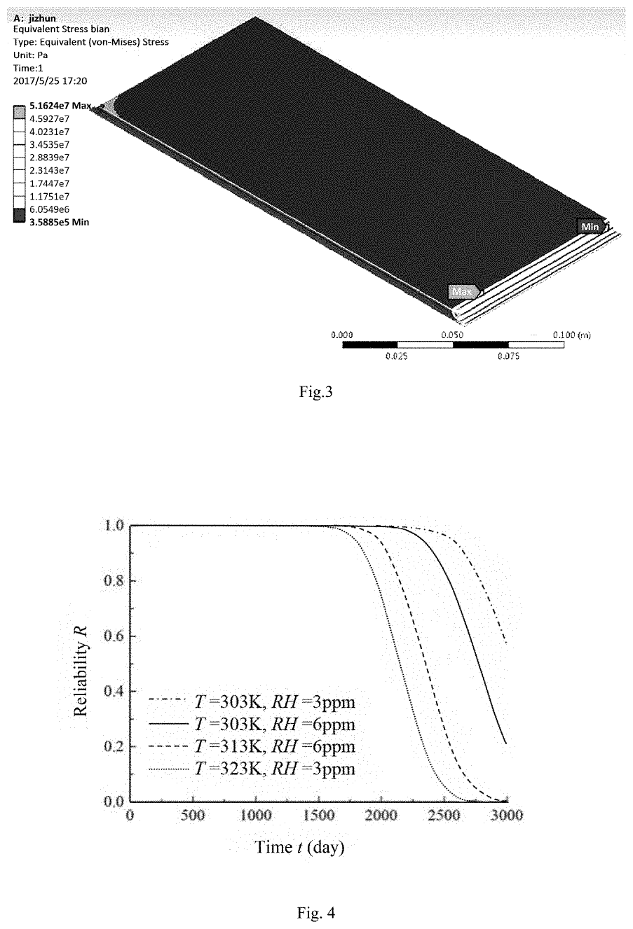

A finite element mechanical simulation model of the soft packing lithium ion battery packing is established. The simulation model is shown in FIG. 3. The stresses at different positions of sealing edges can be obtained by changing the pressure, extracting the stress results at different positions of the sealing edges and fitting the relational expression.

Accordingly, the pressure-stress space model of a side seal is as follows:

s(x)=71.Pr^{0.72}[1−0.05(x−112.5)²]0<x<225

Likewise, the pressure-stress space models of a top seal and a bottom seal are as follows:

s(x)=71. Pr^{0.72}[1−0.05(x−100)²]0<x<200

in this formula, the stress and pressure are represented by Pa, and the distance is represented by mm.

Step 4: constructing a maximum peeling force-strength model

The geometric properties of the samples and the physical properties of the sample materials are substituted into the nonlinear peeling model for calculation, and a quadratic response surface relation between the maximum peeling force P and the interface properties is established, which may be expressed as follows:

P=−2116+8.135×10⁻⁵\hat{σ}−5.519×10⁷δ_{c}−6.087×10⁻¹⁴\hat{σ}²++2.067\hat{σ}δ_{c}+1.362×10¹⁰δ_{c}²

As considering the degradation effects caused by the aging, creeping and electrolyte corrosion, it can be considered that a sealing strength \hat{σ} and a sealing critical length δ_{c} vary over time in a proportion k, and ultimately leading to the degradation of the maximum peeling force. After reviewing the literature, k=0.41; \hat{σ}(0)=43.2 MPa, δ_{c}(0)=43.7 μm. In combination with formulas (5)-(8) and (22), the maximum peeling force-strength model may be determined as follows:

P(t)=−35.3+1.12×10⁻⁶\hat{σ}(t)+b 7.99×10⁻¹⁵\hat{σ}²(t)

Step 5: constructing a maximum peeling force accelerated degradation model

Based on the above acceleration model, accelerated degradation tests under constant stress conditions are carried, out, and the test stress level is determined through a test optimization design. The accelerated degradation tests under different stress levels are carried out on the soft packing entirely. The soft packings degraded at different times are trimmed into the samples with equal width. The maximum peeling force degradation data of the samples at different times are measured through the sample peeling tests, and the values of relevant parameters are obtained by the maximum likelihood fitting.

For example, the side sealing edge and the bottom sealing edge have estimated values as follows: \hat{P}(0)=35N, \hat{λ}=0.52; Â₀=0.31, \hat{m}=0.11, \hat{n}=0.19, Ĉ=−544 , accordingly, the accelerated degradation model of the sealing edge is determined as follows:

$$P ( t ) = Γ ( t ; α ( t ) , 0.52 )$$

$$α ( t ) = 0.52 \times \{ 35 - 0.31 \times {\int }_{0}^{t} P {r}^{0.11} R {H}^{0.19} exp \{ \frac{- 544}{T} ) \cdot d τ \}$$

In addition, a degradation rate of the other side sealing edge (i.e., a secondary side sealing edge) is faster than that of other sealing edges due to the processes, resulting in the estimated value of the degradation parameter A₀ is 0.44, while the other parameters are the same.

The last sealing edge (i.e., the top sealing edge) has no obvious degradation of the maximum peeling force in the test, and an initial maximum peeling force is also different from that of the other edges, that is,

P(0)=P(t)˜Ga(29, 0.39)

Step 6: constructing a maximum peeling force space model

The maximum peeling force at the initial time of each of the positions represented by a stationary process follows the same Gamma distribution, and a correlation coefficient p of the two positions distanced by D satisfies the following relation:

$$ρ ( x , x + D ) = {( \frac{α - 1}{α} )}^{\frac{D}{d}}$$

On the basis of a value obtained in step 5, the correlation coefficient is calculated according to the maximum peeling force test data of each of the positions at the initial time, and the value of d may be fitted.

It is found out from the solution that due to different heat sealing processes, the values d of the side sealing edge and the bottom sealing edge are different from that of the top sealing edge. As for the side sealing edge and the bottom sealing edge, the maximum peeling force space model is as follows:

P(x+2.7)=νP(x)+ϵ

ϵ: E(0.52)

CDF(ν)=ν³⁴, ν∈[0,1]

P(0)˜Ga(35, 0.52)

For the top sealing edge, it is presented as follows:

P(x+3.6)=νP(x)+ϵ

ϵ: E(λ)

CDF(ν)=ν²⁸; ν∈[0,1]

P(0)˜Ga(29, 0.39)

Step 7: constructing multi-dimensional stress-strength interference model

According to the above model, external load conditions are specified for calculation to obtain a stress-time-position curved surface and a strength-time-position curved surface of the soft packing lithium ion battery, and numerical simulation is implemented according to the stress-strength interference theory, and thus predicts the sealing reliability of the soft packing lithium ion battery.

The model may be described as:

$$R ( t ) = P ( {min}_{x} ( \hat{σ} ( t , x ) - s ( t , x ) ) > 0 )$$

where R represents reliability.

Assume that an ambient temperature and water content inside the battery are: T=303K, RH=3 ppm; T=303K, RH=6 ppm ; T=313K, RH=6 ppm ; 1=323K, RH=3 ppm, respectively, a prediction result for the sealing reliability of the soft packing lithium ion battery can be obtained, and the prediction result is shown in FIG. 4.

Finally, it should be noted that the above-mentioned embodiments are only used to illustrate the technical solution of the present disclosure, rather than limit the present disclosure. Although the present disclosure has been described in detail with reference to the foregoing embodiments, it should be understood by the person skilled in the art that it is allowable to modify the technical solution described in the foregoing embodiments or equivalently substituting some or all of the technical features; however, these modifications or substitutions do not cause the corresponding technical solutions to substantively depart from the scope of the technical solutions of various embodiments of the present disclosure.

1. A method for predicting sealing reliability of a soft packing lithium ion battery, wherein the method includes steps of:
S1, determining a key degradation mechanism:
wherein sealing failure modes of the soft packing lithium ion battery are analyzed to find out key failure modes and carry out mechanism analysis, and determine key failure mechanisms and respective sensitive stresses, and according to analysis results of the mechanism, the key failure mechanisms of sealing failure of the soft packing lithium ion battery are determined as aging, creeping and electrolyte corrosion, and the respective sensitive stresses are determined as temperature, pressure and water content, respectively;
S2, constructing a pressure-time model:
wherein by counting pressure-time data of samples of the different soft packing lithium ion battery, model data is fitted by using a maximum likelihood fitting method, to obtain the pressure-time model as follows:
$$P r ( t ) = Γ ( t ; {α}_{1} ( t ) , {λ}_{1} ) \\ {α}_{1} ( t ) = {λ}_{1} \{ {A}_{f} exp ( \frac{{C}_{f}}{T} ) t + P {r}_{0} \}$$
wherein Γ(t;αZ(t), λ) represents a Gamma process evolving over time t; α(t) is a shape parameter of the process; λ is a scale parameter; t is time; T is temperature; Pr₀ is a mean value of an initial pressure; A_{f}, and C_{f} are constants; the pressure-time model means that the pressure of the soft packing lithium ion battery follows the Gamma process along with change of the time, and the temperature affects the pressure by influencing shape parameter values of the Gamma process;
S3, constructing a pressure-stress space model:
wherein an internal pressure of the soft packing lithium ion battery uniformly acts on an inner face of the packing, so as to generate a tensile force at a seal, and generate a normal positive stress at a sealing and bonding interface; a relation formula is fitted by establishing a finite element mechanical simulation model, changing the pressure, and extracting results of stress at different positions of a sealing edge, stress values under various pressure conditions are obtained by utilizing the stress simulation on the soft packing lithium ion battery entirely, and thereby constructing the pressure-stress space model as follows:
$$s ( x ) = a \cdot {Pr}^{b} [ 1 - {c ( x - \frac{l}{2} )}^{2} ] 0 < x < l$$
where s is stress; x is a coordinate of a spatial position, representing a distance from the position to an end point of the sealing edge; l is a length of the sealing edge; a, b, c are constants; the pressure-stress space model means that the stress at a certain point on the inner face of the packing and the pressure are in a power function relation, the stress values at the different positions of the same sealing edges are symmetrical with respect to a midpoint of the sealing edge, and the stress at the midpoint of the sealing edge is maximum;
S4, constructing a maximum peeling force-strength mode:
geometric properties of the sample and physical properties of the sample material are substituted into a non-linear stripping model for calculation, to establish a quadratic response surface relation formula between a maximum peeling force P and the interface properties, and thus constructing the maximum peeling force-strength model as follows:
P=c₀+c₁\hat{σ}+c₂δ_{c}+c₃\hat{σ}²+c₄\hat{σ}δ_{c}+c₅δ_{c}²
wherein P is the maximum peeling force, c₀, c₁, c₂, c₃, c₄, c₅ are constants, \hat{σ} is bonding strength, and δ_{c} is a characteristic length;
S5, constructing a maximum peeling force accelerated degradation model:
according to the analysis results of the failure mechanism, constructing the maximum peeling force accelerated degradation model as follows:
$$\frac{d P}{d t} = {A}_{0} P {r}^{m} R {H}^{n} exp ( \frac{C}{T} )$$
wherein
$$\frac{dP}{d t}$$
is a degradation rate of the maximum peeling force, A₀ is a test constant, RH is a battery internal water content, Pr is the pressure, C is a ratio of the activation energy to the Boltzmann constant, m is a power law index of the pressure, and n is a power law index of the water content;
and then, introducing the Gamma process to further characterize the degradation process of the maximum peeling force, at this time, constructing the maximum peeling force accelerated degradation model as follows:
$$P ( t ) = Γ ( t ; α ( t ) , λ )$$
$$α ( T ) = λ \{ {P}_{0} - {A}_{0} \cdot {\int }_{0}^{t} P {r}^{m} R {H}^{n} exp ( \frac{C}{T} ) \cdot d τ \} ;$$
the maximum peeling force accelerated degradation model means that the maximum peeling force follows the Gamma process according to a rule of variation over time, and environmental factors such as the temperature, the pressure and the battery internal water content affect the pressure by affecting the shape parameter values of the Gamma process;
S6, constructing a maximum peeling force space model:
wherein from step S5, it is obtained that the value of maximum peeling force at a certain time follows Gamma distribution, and an initial maximum peeling force at each of the positions follows the same distribution, and thereby constructing the maximum peeling force space model as follows:
P(x+d)=νP(x)+ϵ
ϵ: E(λ)
CDF(ν)=ν^{α-1};ν∈[0,1]
P(0)˜Ga(α,λ)
the formula means that the initial maximum peeling force P(x+d) separated by d is generated from the value P(x) of the previous position, wherein ϵ follows an exponential distribution of the parameters λ; ν follows a power law distribution from 0 to 1 and its cumulative distribution function CDF is a power function; the value P(0) of the initial position follows the Gamma distribution; the maximum peeling force at the initial time of each of the positions represented by a stationary process follows the same Gamma distribution, and a correlation coefficient ρ of the two positions distanced by D satisfies relation below:
$$ρ ( x , x + D ) = {( \frac{α - 1}{α} )}^{\frac{D}{d}}$$
thereby calculating a correlation coefficient according to the test data of the maximum peeling force at each of the positions at the initial time and fitting the value of the positions separated by d;
S7: constructing multi-dimensional stress-strength interference model and predicting the reliability:
wherein according to the models constructed in steps S2 to S6, external load conditions are specified for calculation to obtain a stress-time-position curved surface and a strength-time-position curved surface of the soft packing lithium ion battery, and numerical simulation is implemented according to the stress-strength interference theory, to obtain the reliability value R, and the multi-dimensional stress-strength interference model used for the numerical simulation as follows:
$$R ( t ) = P ( {min}_{x} ( \hat{σ} ( t , x ) - s ( t , x ) ) > 0 )$$
wherein, R represents the reliability, and the multi-dimensional stress-strength interference model means that the reliability R(t) of a certain point t at the time dimension is a probability that the weakest portion at each of the sealing edges is able to normally work at the time t, that is, the probability that the minimum value of the difference between the bonding strength and the bonding stress at each of the positions of the sealing edges is greater than zero.

2. The method for predicting sealing reliability of a soft packing lithium ion battery according to claim 1, wherein the key failure mode as described in step 1 refers to a failure representation occurring at a highest frequency in the sealing failure types of the soft packing lithium ion battery in the whole life cycle; the key failure mechanism refers to an internal physical or chemical process of the key failure mode; and the sensitive stress refers to an applied load leading to occurrence of the key failure mechanism.

3. The method for predicting sealing reliability of the soft packing lithium ion battery according to claim 1, wherein the maximum likelihood method as described in step 2 refers to that a plurality of pressure distributions to be obtained and a process parameter set are arbitrarily given, sequentially substituted into known data points to obtain probability density function values, and then all probability density function values are multiplied, so that the likelihood function values are obtained; and according to an optimization algorithm iterative calculation rule, after each iteration, the parameter set corresponding to the larger likelihood function value is selected as the output of this iteration, repeat the process until the difference between the likelihood function values before and after each iteration is less than a given error limit, at this time, the parameter set with the largest likelihood function value is taken as a result, and thus a solution is completed.

4. The method for predicting sealing reliability of the soft packing lithium ion battery according to claim 1, wherein in step S3, the stress values under various pressure conditions are obtained by carrying out stress simulation on the soft packing lithium ion battery entirely, and specifically steps are as follows:
S31, establishing a geometric model of a soft packing by using three-dimensional modeling software;
S32, importing the geometric model of the soft packing into a simulation software, parameterizing the pressure and mechanical properties of the packing, and establishing a parametric model of the packing;
S33, setting a grid of the packing parameter model in the simulation software, contacting options, determining constraining and loading methods, and carrying out simulation and extracting the maximum stress at the sealing edges.

5. The method for predicting sealing reliability of the soft packing lithium ion battery according to claim 1, wherein the nonlinear peeling model as described in step S4 refers to solving the maximum peeling force of the sample when applying a symmetrical tensile load under the geometric attribute of the sample and the physical attribute of the sample material by using an elastoplastic mechanic theory, under the consideration of the nonlinear stress-strain relationship of the packing material.

6. The method for predicting sealing reliability of the soft packing lithium ion battery according to claim 1, wherein in step S5, an accelerated degradation test under a constant stress condition is carried out based on the maximum peeling force accelerated degradation model, and combination of a number of test sets and a stress level is determined through a test optimization design; accelerated degradation tests at different stress levels are carried out on the soft packing entirely, and the soft packings subjected to degradation at different times are trimmed into samples with equal widths; the maximum peeling force degradation data of samples at different times is obtained through peeling tests of the samples, and the maximum likelihood fitting is used to obtain the values of relevant parameters.

7. The method for predicting sealing reliability of the soft packing lithium ion battery according to claim 6, wherein the test optimization design as described in step S5 refers to determining the combination of the stress levels by using an orthogonal design method, for carrying out the accelerated degradation tests.

8. The method for predicting sealing reliability of the soft packing lithium ion battery according to claim 1, wherein in step S7, the numerical simulation is carried out according to the stress-strength interference theory, and obtaining the value of the reliability R specializes in that a sampling program is compiled by using the Monte Carlo method to generate a large number of strength and stress values at different positions at different times for comparison and calculation, and the probability of no failure is taken as a final reliability.

9. The method for predicting sealing reliability of the soft packing lithium ion battery according to claim 5, wherein when degradation effects caused by aging, creep and electrolyte corrosion are considered in step S4, the bonding strength \hat{σ} and the sealing critical length δ_{c} vary over time in a proportion k, thereby causing degradation of the maximum peeling force, and an expression for collaboration relationship is as follows:
$$\hat{σ} ( t ) = \hat{σ} ( 0 ) {S}_{1} \\ {δ}_{c} ( t ) = {δ}_{c} ( 0 ) {S}_{2} \\ k = \frac{1 - {S}_{2}}{1 - {S}_{1}} \\ P ( t ) = {f}_{1} ( \hat{σ} ( t ) , k )$$
wherein S is an environmental degradation factor within a value range between 0 and 1, and physically means a ratio of reduction of the two parameters of the bonding strength and the critical length caused by the environmental load, while the maximum peeling force-strength model in S4 is denoted as f₁.
